(19) United States
(12) Patent Application Publication
(10) Pub. No.: US 2025/0112424 A1
(43) Pub. Date: Apr. 3, 2025

(54) CONNECTOR AND ELECTRONIC DEVICE

(71) Applicant: VIVO MOBILE COMMUNICATION CO., LTD., Dongguan (CN)

(72) Inventor: Xinmiao DAN, Dongguan (CN)

(73) Assignee: VIVO MOBILE COMMUNICATION CO., LTD., Dongguan (CN)

(21) Appl. No.: 18/979,561

(22) Filed: Dec. 12, 2024

Related U.S. Application Data
(63) Continuation of application No. PCT/CN2023/100263, filed on Jun. 14, 2023.

(30) Foreign Application Priority Data
Jun. 16, 2022 (CN) 202210681158.4

(51) Int. Cl. H01R 24/30; H01R 13/66

(52) U.S. Cl. CPC H01R 24/30; H01R 13/6616

(57) ABSTRACT

A connector and an electronic device are provided. The connector specifically includes an interface and a connecting cable. The interface includes a housing, a plastic body, and a plurality of metal terminals. A plurality of first mounting grooves are provided on the plastic body. The metal terminals are in one-to-one correspondence with the first mounting grooves. One of the metal terminals is correspondingly mounted in one of the first mounting grooves. The housing is sleeved outside the plastic body. The plurality of metal terminals includes a power terminal and a ground terminal. The power terminal includes at least two power pins electrically connected to each other, and the ground terminal includes at least two ground pins electrically connected to each other. The metal terminals are all directly electrically connected to the connecting cable.

### CROSS-REFERENCE TO RELATED APPLICATIONS

This application is a continuation of International Application No. PCT/CN 2023/100263, filed on Jun. 14, 2023, which claims priority to Chinese Patent Application No. 202210681158.4, filed on Jun. 16, 2022. The entire contents of each of the above-referenced applications are expressly incorporated herein by reference.

### TECHNICAL FIELD

This application pertains to the field of communication technologies, and specifically, to a connector and an electronic device.

### BACKGROUND

As functions of an electronic device such as a mobile phone or a tablet computer become more powerful, a user uses the electronic device more frequently. Correspondingly, use of a connector for data transmission with an external device and charging in the electronic device is increasingly frequent, and performance of the connector also gains widespread attention. In some embodiments, the connector may generally include a data cable and an interface. The interface may be configured to be connected to an interface on the electronic device. Because a Type-C interface has advantages of high transmission efficiency, high charging efficiency, and being suitable for plugging in from both front and back sides without adjusting a plugging direction, a connector having the Type-C interface gains widespread attention.

In a related technology, because the Type-C interface has more metal terminals, to implement a fixed connection of the metal terminals, a plurality of metal terminals need to be fixed to a circuit board. An electrical connection between some of the metal terminals is implemented by using the circuit board, and then the circuit board is connected to a data cable, to implement an electrical connection between the metal terminals and the data cable by using the circuit board. In other words, the circuit board needs to be disposed in the connector.

However, when the circuit board is disposed in the connector to connect the metal terminals, an adhesive-sealing structure usually needs to be disposed additionally to protect solder pin of the terminals, so as to prevent the circuit board from being distorted and improve overall strength of the circuit board. As a result, an overall volume and processing difficulty of the connector are easily increased, and costs of the connector are increased. In addition, the electrical connection between the metal terminals is implemented based on wiring on the circuit board. Because the wiring on the circuit board is small, an overcurrent capability of the connector is greatly limited, and operating efficiency of the connector is reduced.

### SUMMARY

This application intends to provide a connector and an electronic device.

This application is implemented as follows.

According to a first aspect, this application discloses a connector, and the connector includes an interface and a connecting cable. The interface includes a housing, a plastic body, and a plurality of metal terminals.

A plurality of first mounting grooves are provided on the plastic body, the metal terminals are in one-to-one correspondence with the first mounting grooves, one of the metal terminals is correspondingly mounted in one of the first mounting grooves, and the housing is sleeved outside the plastic body.

The plurality of metal terminals includes a power terminal and a ground terminal. The power terminal includes at least two power pins electrically connected to each other, and the ground terminal includes at least two ground pins electrically connected to each other.

The metal terminals are all directly electrically connected to the connecting cable.

According to a second aspect, this application further discloses an electronic device, and the electronic device includes a device body and the connector according to any one described above.

The connector is configured to be plugged in the device body.

In embodiments of this application, at least two power pins are connected to each other to form the power terminal, and at least two ground pins are connected to each other to form the ground terminal. The metal terminal is directly electrically connected to the connecting cable, so that an operation of disposing a circuit board in the interface to connect the metal terminal to the connecting cable is avoided, a quantity of parts in the interface and an assembly process are reduced, assembly convenience is improved, a volume of the interface is reduced, and processing difficulty and costs of the interface are reduced. In addition, because the at least two power pins may be electrically connected to each other, and the at least two ground pins may also be electrically connected to each other, a connecting portion between the power pins and a connecting portion between the ground pins may be set to be large, and therefore an overcurrent capability is strong. In this way, operating efficiency of the connector can be greatly improved.

Additional aspects and advantages of this application will be given in the following descriptions, some of which will become apparent from the following descriptions or may be learned from the practice of this application.

### BRIEF DESCRIPTION OF THE DRAWINGS

To describe the technical solutions in embodiments of this application or in a conventional technology more clearly, the accompanying drawings required for describing the embodiments or the conventional technology are briefly described below. Apparently, the accompanying drawings in the following descriptions show some embodiments of this application, and a person of ordinary skill in the art may still derive other drawings from these accompanying drawings without creative efforts.

FIG. 1 is a schematic diagram of a structure of a connector according to an embodiment of this application;

FIG. 2 is a schematic diagram of an exploded structure of the connector shown in FIG. 1;

FIG. 3 is a schematic diagram of a structure of a plastic body in the connector shown in FIG. 1;

FIG. 4 is a schematic diagram of a structure of a power terminal according to an embodiment of this application;

FIG. 5 is a schematic diagram of a structure of a ground terminal according to an embodiment of this application;

FIG. 6 is a schematic diagram of a structure of a common terminal according to an embodiment of this application; and

FIG. 7 is a schematic diagram of a structure of a protection member according to an embodiment of this application.

Reference numerals: 10—housing; 11—plastic body; 111—first mounting groove; 112—second mounting groove; 12—power terminal; 121—power pin; 122—first transverse beam; 123—first terminal solder pin; 13—ground terminal; 131—ground pin; 132—second transverse beam; 133—second terminal solder pin; 134—elastic sheet; 14—clamping hook; 15—common terminal; 151—bending platform; 16—first signal terminal; 17—second signal terminal; 18—Vconn terminal; 19—resistor; 20—protection member; and 201—third mounting groove.

### DETAILED DESCRIPTION

To make the objectives, technical solutions, and advantages of embodiments of this application clearer, the following describes the technical solutions in embodiments of this application with reference to the accompanying drawings in embodiments of this application. Apparently, the described embodiments are merely a part rather than all of the embodiments of this application. All other embodiments obtained by a person of ordinary skill in the art based on embodiments of this application without creative efforts shall fall within the protection scope of this application.

A feature of the term “first” or “second” in the specification and claims of this application may explicitly or implicitly include one or more of the features. In the descriptions of this application, unless otherwise stated, “a plurality of” means two or more than two. In addition, in the specification and claims, “and/or” indicates at least one of the connected objects, and the character “/” generally indicates an “or” relationship between the associated objects.

In the descriptions of this application, it should be understood that, orientation or position relationships indicated by the terms such as “center”, “longitudinal”, “transverse”, “length”, “width”, “thickness”, “on”, “below”, “front”, “back”, “left”, “right”, “vertical”, “horizontal”, “top”, “bottom”, “inside”, “outside”, “clockwise”, “anticlockwise”, “axial direction”, “radial direction”, and “circumferential direction” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, these terms should not be understood as limiting of this application.

In the descriptions of this application, it should be noted that, unless otherwise explicitly specified or defined, the terms such as “mount”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. A person of ordinary skill in the art may understand specific meanings of the foregoing terms in this application based on specific situations.

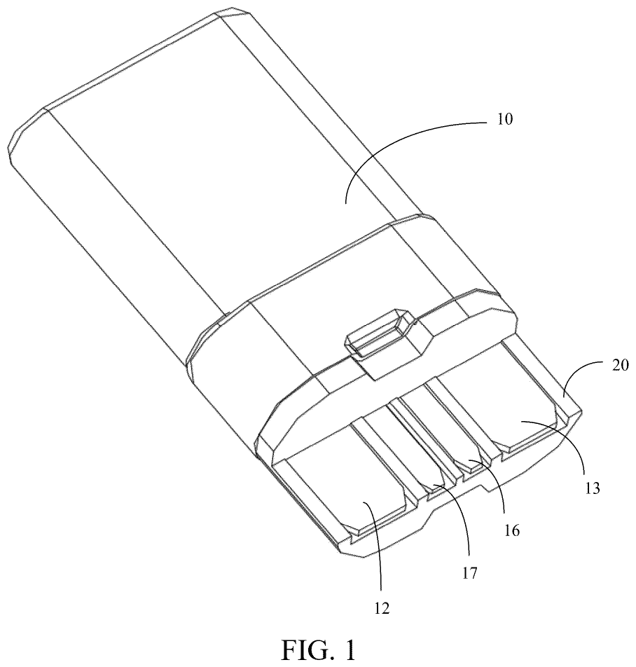

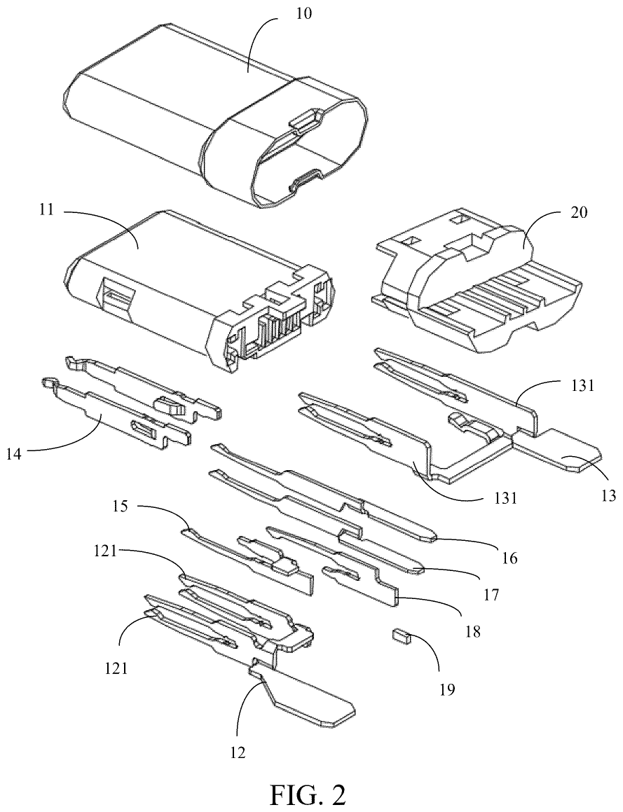

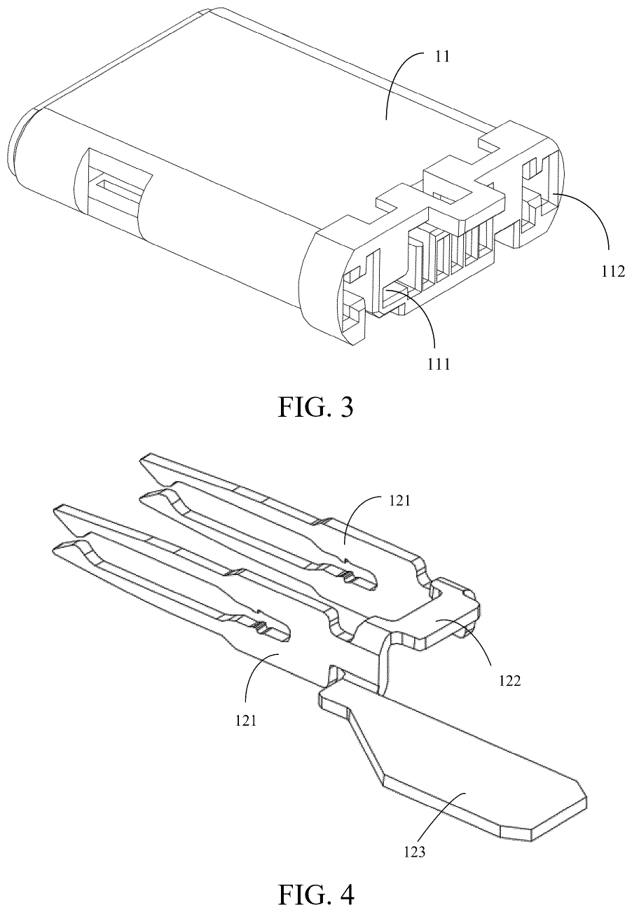

FIG. 1 is a schematic diagram of a structure of a connector according to an embodiment of this application. FIG. 2 is a schematic diagram of an exploded structure of the connector shown in FIG. 1. FIG. 3 is a schematic diagram of a structure of a plastic body in the connector shown in FIG. 1.

In some embodiments, the connector includes an interface (as shown in FIG. 1) and a connecting cable (not shown in the figure). For example, the interface includes a housing 10, a plastic body 11, and a plurality of metal terminals. A plurality of first mounting grooves 111 are provided on the plastic body 11, the metal terminals are in one-to-one correspondence with the first mounting grooves 111, one of the metal terminals is correspondingly mounted in one of the first mounting grooves 111, and the housing 10 is sleeved outside the plastic body 11. The plurality of metal terminals includes a power terminal 12 and a ground terminal 13. The power terminal 12 includes at least two power pins 121 electrically connected to each other, and the ground terminal 13 includes at least two ground pins 131 electrically connected to each other. The metal terminals are all directly electrically connected to the connecting cable.

In this embodiment of this application, the at least two power pins 121 are connected to each other to form the power terminal 12, and the at least two ground pins 131 are connected to each other to form the ground terminal 13. The metal terminal is directly electrically connected to the connecting cable, so that an operation of disposing a circuit board in the interface to connect the metal terminal to the connecting cable is avoided, a quantity of parts in the interface and an assembly process are reduced, assembly convenience is improved, a volume of the interface is reduced, and processing difficulty and costs of the interface are reduced. In addition, because the at least two power pins 121 may be electrically connected to each other, and the at least two ground pins 131 may also be electrically connected to each other, a connecting portion between the power pins 121 and a connecting portion between the ground pins 131 may be set to be large, and therefore an overcurrent capability is strong. In this way, operating efficiency of the connector can be greatly improved.

In some embodiments, the interface may be configured to be connected to an interface in an electronic device, and the connecting cable may be configured to be connected to an external device or a charging brick, to implement data transmission between the electronic device and the external device or to charge the electronic device. The interface may be a Type-C interface, so that the interface has advantages of high transmission efficiency, high charging efficiency, and being suitable for plugging in from both front and back sides without adjusting a plugging direction. In some embodiments, the interface may be another interface. A type of the interface may not be specifically limited in this embodiment of this application.

In this embodiment of this application, because the power terminal 12 may include the at least two power pins 121 electrically connected to each other, the power terminal 12 may be directly electrically connected to the connecting cable. In comparison with a conventional technology in which two independent power terminals need to be disposed and the two independent power terminals are soldered to a circuit board, a quantity of power terminals may be reduced in this embodiment of this application. Similarly, because the ground terminal 13 may include the at least two ground pins 131 electrically connected to each other, the ground terminal 13 may be directly electrically connected to the connecting cable. In comparison with a conventional technology in which two independent ground terminals need to be disposed and the two independent ground terminals are soldered to the circuit board, a quantity of ground terminals may be reduced in this embodiment of this application.

During actual application, a total quantity of metal terminals in the interface can be reduced by reducing the quantity of power terminals and the quantity of ground terminals. In addition, the metal terminal is directly electrically connected to the connecting cable, so that an operation of disposing the circuit board in the interface to connect the metal terminal to the connecting cable is avoided. Therefore, in this application, a quantity of parts in the interface and an assembly process are reduced, thereby improving assembly convenience of the interface.

In this embodiment of this application, because the electrical connection between the metal terminal and the connecting cable is not implemented by disposing the circuit board in the connector, but instead, a tail of the metal terminal is directly soldered to the connecting cable, a soldering portion in the interface can be reduced. In this way, a distance between two metal terminals for soldering in the interface can be increased. Therefore, a distance between soldering portions of two adjacent metal terminals is also correspondingly increased, to avoid a defect that a short circuit occurs between the soldering portions of the two adjacent metal terminals and improve operating reliability of the connector.

For example, in an existing connector, a distance between two adjacent metal terminals is usually about 0.3 millimeters. Correspondingly, a distance between soldering portions of the two adjacent metal terminals is also short. However, in this embodiment of this application, the metal terminal is directly soldered to the connecting cable, so that a distance between two adjacent metal terminals can be increased, and the distance between the two adjacent metal terminals can be increased to about 0.42 millimeters. Correspondingly, a distance between soldering portions of the two adjacent metal terminals can also be increased, and a probability of a short circuit between the soldering portions can be further reduced, thereby greatly improving the operating reliability of the connector.

In some embodiments, the plastic body 11 serves as a structural body of the interface, so that the plastic body 11 may be configured to support the plurality of metal terminals and play an insulation role. In some embodiments, the plastic body 11 may be manufactured through injection molding by using a plastic material. The housing 10 may be made of metal, and the housing 10 is sleeved outside the plastic body 11. The housing 10 may be configured to fix the plastic body 11 and provide strength of the interface.

During actual application, the interface may further include two clamping hooks 14. When the interface is plugged in the electronic device, the clamping hook 14 may be configured to provide a force of plugging and unplugging. Correspondingly, two second mounting grooves 112 may be further provided in the plastic body 11. One second mounting groove 112 may be configured to mount one clamping hook 14.

In some embodiments, after the interface is plugged in the electronic device, the metal terminal in the interface may be electrically connected to a metal terminal in a structure of the electronic device, to charge the electronic device or implement signal transmission.

As shown in FIG. 2, for example, the plurality of metal terminals may include the power terminal 12 (a VBUS terminal), the ground terminal 13 (a GND terminal), a common terminal 15 (a CC terminal), a first signal terminal 16 (a D+terminal), a second signal terminal 17 (a D-terminal), and a Vconn terminal 18. The power terminal 12 may be configured with a voltage to implement a charging function. The ground terminal 13 may be configured to implement a charging function and grounding of the housing 10. The common terminal 15 may be configured to detect a connection, to identify a front or back plugging of a plug. The first signal terminal 16 and the second signal terminal 17 may be compatible with data transmission of a USB 2.0 protocol. The Vconn terminal 18 may be configured to supply power to a chip in a cable.

In some embodiments of this application, the at least two power pins 121 in the power terminal 12 may be of an integrally formed structure. In this way, on one hand, a relative position between the at least two power pins 121 can be maintained fixed and an electrical connection between the at least two power pins 121 can be implemented, to help integrally solder the power terminal 12 to the connecting cable. Therefore, an operation of using the circuit board to fix and connect the at least two power pins 121 is avoided, a volume of the interface is reduced, and processing difficulty and costs of the interface are reduced. On the other hand, an operation of processing the power pins 121 independently and connecting the power pins 121 can also be reduced, thereby greatly improving processing efficiency of the power terminal 12.

In some embodiments, the power terminal 12 may be formed in a manner of bending or stamping, to process the at least two power pins 121 in the power terminal 12 into the integrally formed structure.

Similarly, the at least two ground pins 131 in the ground terminal 13 may also be of an integrally formed structure. In this way, on one hand, a relative position between the at least two ground pins 131 can be maintained fixed and an electrical connection between the at least two ground pins 131 can be implemented, to help integrally solder the ground terminal 13 to the connecting cable. Therefore, an operation of using the circuit board to fix and connect the at least two ground pins 131 is avoided, the volume of the interface is reduced, and the processing difficulty and the costs of the interface are reduced. On the other hand, an operation of processing the ground pins 131 independently and connecting the ground pins 131 can also be reduced, thereby greatly improving processing efficiency of the ground terminal 13.

In some embodiments, the ground terminal 13 may be formed in a manner of bending or stamping, to process the at least two ground pins 131 in the ground terminal 13 into the integrally formed structure.

FIG. 4 is a schematic diagram of a structure of a power terminal according to an embodiment of this application. As shown in FIG. 4, the power terminal 12 may further include a first transverse beam 122 and a first terminal solder pin 123. The first transverse beam 122 is connected to the at least two power pins 121 respectively, the first terminal solder pin 123 is connected to the first transverse beam 122, and the connecting cable is electrically connected to the first terminal solder pin 123.

During actual application, the power pin 121, the first transverse beam 122, and the first terminal solder pin 123 may be processed into an integrally formed structure in a manner of bending or stamping. In some embodiments, one power pin 121 may be configured to be connected to one power terminal 12 in the interface of the electronic device, to implement voltage configuration and a charging function. The first transverse beam 122 may be configured to implement a connection between the power pins 121 and maintain a relative position between the power pins 121 fixed. Compared with a wiring on the circuit board (having a thickness of about 0.05 millimeters), a thickness of the first transverse beam 122 may reach 0.25 millimeters or even larger, to implement a large overcurrent capability and greatly improve operating efficiency of the power terminal 12. The first terminal solder pin 123 may be soldered and connected to the connecting cable, to implement an electrical connection between the power terminal 12 and the connecting cable.

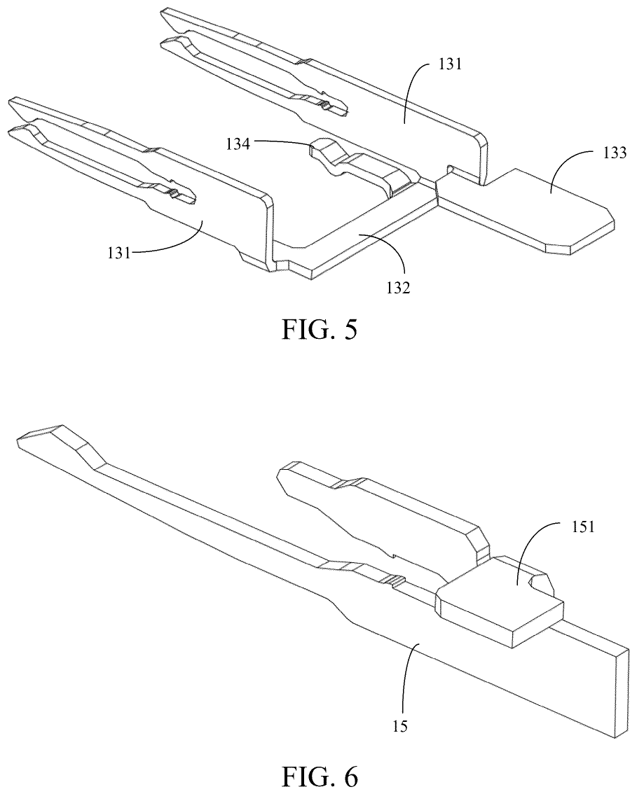

FIG. 5 is a schematic diagram of a structure of a ground terminal according to an embodiment of this application. As shown in FIG. 5, the ground terminal 13 may further include a second transverse beam 132 and a second terminal solder pin 133. The second transverse beam 132 is connected to the at least two ground pins 131 respectively, the second terminal solder pin 133 is connected to the second transverse beam 132, and the connecting cable is electrically connected to the second terminal solder pin 133.

During actual application, the ground pin 131, the second transverse beam 132, and the second terminal solder pin 133 may be processed into an integrally formed structure in a manner of bending or stamping. In some embodiments, one ground pin 131 may be configured to be connected to one ground terminal 13 in the interface of the electronic device, to ground and the charging function. The second transverse beam 132 may be configured to implement a connection between the ground pins 131 and maintain a relative position between the ground pins 131 fixed. Compared with the wiring on the circuit board (having a thickness of about 0.05 millimeters), a thickness of the second transverse beam 132 may reach 0.25 millimeters or even larger, to implement a large overcurrent capability and greatly improve operating efficiency of the ground terminal 13. The second terminal solder pin 133 may be soldered and connected to the connecting cable, to implement an electrical connection between the ground terminal 13 and the connecting cable.

In some embodiments of this application, an elastic sheet 134 toward the housing 10 is disposed on the second transverse beam 132, and the elastic sheet 134 abuts against the housing 10, to ground of the housing 10. In this way, an operation of soldering the ground terminal 13 to the housing 10 can be avoided, thereby simplifying a processing process of the interface.

During actual application, because the elastic sheet 134 toward the housing 10 is disposed on the second transverse beam 132, after the ground terminal 13 is mounted in the plastic body 11, the elastic sheet 134 may abut against the housing 10 to implement the grounding of the housing 10. Compared with a manner in which the housing 10 is grounded by soldering between the housing 10 and the ground terminal 13 in a conventional technology, this application greatly simplifies the grounding implementation of the housing 10.

In some embodiments, the interface may further include a resistor 19, and the plurality of metal terminals may further include a common terminal 15. The resistor 19 is electrically connected to the common terminal 15 and the power terminal 12 separately. After the connector is plugged in the electronic device, the resistor 19 may be used as an identification resistor to implement identity identification of the connector.

During actual application, after the connector is plugged in the electronic device, due to existence of the resistor 19, the electronic device may obtain a detection voltage corresponding to a resistance value of the resistor 19. Based on the detection voltage, the electronic device may identify a type of the connector, and select a charging protocol matching the type of the connector for charging.

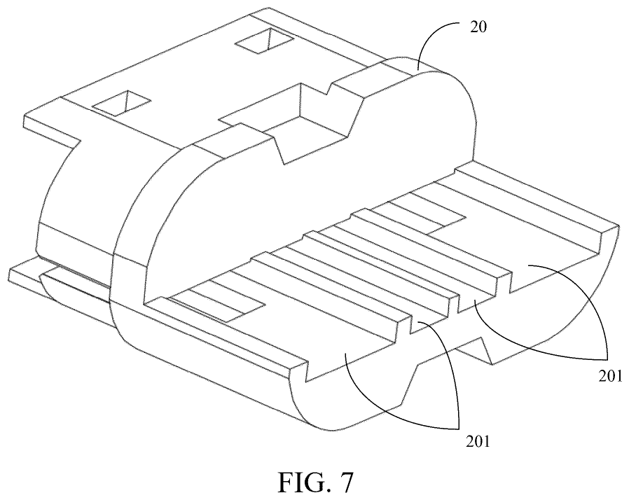

FIG. 6 is a schematic diagram of a structure of a common terminal according to an embodiment of this application. As shown in FIG. 6, a bending platform 151 is disposed on the common terminal 15, and the resistor 19 is soldered to the bending platform 151. During actual application, the resistor 19 may be at least partially overlapped on the bending platform 151, and the resistor 19 is soldered to the bending platform 151 by using a soldering process. Because a surface of the bending platform 151 is flat, when the resistor 19 is overlapped on the bending platform 151, a contact area between the resistor 19 and the bending platform 151 is large. In this way, a soldering operation between the resistor 19 and the bending platform 151 can be easily performed, and a soldering connection between the resistor 19 and the bending platform 151 can be reliable.

In some embodiments, the power terminal 12 further includes the first transverse beam 122. The first transverse beam 122 is connected to the at least two power pins 121 respectively. The resistor 19 is soldered to the first transverse beam 122. Compared with the power pin 121 and the first terminal solder pin 123 in the power terminal 12, the first transverse beam 122 has a regular shape and a flat surface. When the resistor 19 is overlapped on the first transverse beam 122, a contact area between the resistor 19 and the first transverse beam 122 is large. In this way, a soldering operation between the resistor 19 and the first transverse beam 122 can be easily performed, and a soldering connection between the resistor 19 and the power terminal 12 can be reliable.

In some embodiments, the interface may further include a protection member 20. The protection member 20 is connected to a side of the plastic body 11 close to the connecting cable. The protection member 20 is connected to the plurality of metal terminals, to support the plurality of metal terminals and implement insulation between the plurality of metal terminals.

During actual application, the protection member 20 may be made of a plastic material. The protection member 20 may be connected to a side of the plastic body 11 close to the connecting cable, to support tails of the plurality of metal terminals, so as to facilitate soldering of the tails of the plurality of metal terminals to the connecting cable, and improve operability of soldering and connection of the metal terminals to the connecting cable. In addition, the protection member 20 may also be configured to implement insulation between the plurality of metal terminals, to avoid a short circuit caused by an electrical connection between the metal terminals.

In some embodiments, the protection member 20 and the plastic body 11 may be of a separated structure, so that structures of a single protection member 20 and a single plastic body 11 are simple and a connection manner is flexible. For example, the protection member 20 and the plastic body 11 may be of an integrated structure, so that the protection member 20 and the plastic body 11 are obtained through integrally processing, to reduce production costs.

FIG. 7 is a schematic diagram of a structure of a protection member according to an embodiment of this application. As shown in FIG. 7, a plurality of third mounting grooves 201 are provided on the protection member 20. The third mounting grooves 201 may be in one-to-one correspondence with the metal terminals, and one third mounting groove 201 may be configured to mount one metal terminal, to implement insulation between the metal terminals.

An example of an assembly process of the connector described in this embodiment of this application is provided below.

First, the clamping hook 14 may be mounted into the second mounting groove 112 of the plastic body 11. Next, the common terminal 15, the Vconn terminal 18, the first signal terminal 16, the second signal terminal 17, the power terminal 12, and the ground terminal 13 are sequentially inserted into the first mounting groove 111 of the plastic body 11. Then, the protection member 20 is mounted from a tail of the plastic body 11 and fit with the metal terminal and the plastic body 11. Then, the resistor 19 is soldered to the first transverse beam 122 of the power terminal 12 and the bending platform 151 of the common terminal 15, and the plastic body 11 is mounted into the housing 10 to obtain the interface.

Finally, the interface may be soldered and connected to the connecting cable, and a complete connector is assembled by using a related process.

During use of the connector, the connector may be plugged into an interface of a corresponding electronic device, the power terminal 12 and the ground terminal 13 form a loop in a circuit, and the device identifies the resistor 19 between the common terminal 15 and the power terminal 12, so that the connector can output a specific current based on a protocol during operation, to implement high-power charging.

In conclusion, the connector in this embodiment of this application may include at least the following advantages.

In this embodiment of this application, at least two power pins are connected to each other to form the power terminal, and at least two ground pins are connected to each other to form the ground terminal. The metal terminal is directly electrically connected to the connecting cable, so that an operation of disposing a circuit board in the interface to connect the metal terminal to the connecting cable is avoided, a quantity of parts in the interface and an assembly process are reduced, assembly convenience is improved, a volume of the interface is reduced, and processing difficulty and costs of the interface are reduced. In addition, because the at least two power pins may be electrically connected to each other, and the at least two ground pins may also be electrically connected to each other, a connecting portion between the power pins and a connecting portion between the ground pins may be set to be large, and therefore an overcurrent capability is strong. In this way, operating efficiency of the connector can be greatly improved.

An embodiment of this application provides an electronic device. For example, the electronic device may include a device body and the connector according to any one of the foregoing embodiments. The connector is configured to be plugged in the device body.

In some embodiments, the device body may include, but is not limited to, at least one of a mobile phone, a tablet computer, and a wearable device. A specific type of the device body may not be limited in this embodiment of this application. In addition, a specific structure of the connector may be the same as that of the connector in the foregoing embodiments, and beneficial effects thereof are of the same type. Details are not described herein again.

The described apparatus embodiment is merely exemplary. The units described as separate parts may or may not be physically separate, and parts displayed as units may or may not be physical units, may be located in one position, or may be distributed on a plurality of network units. A part of or all of the modules may be selected based on an actual need to achieve the objectives of the solutions of the embodiments. A person of ordinary skill in the art may understand and implement the embodiments without creative efforts.

“One embodiment”, “embodiment”, or “one or more embodiments” mentioned in the specification means that particular features, structures, or characteristics described with reference to the embodiment are included in at least one embodiment of this application. In addition, it should be noted that the word examples such as “in an embodiment” do not necessarily all refer to a same embodiment.

Numerous specific details are described in the specification provided herein. However, it can be understood that, embodiments of this application may be practiced without the specific details. In some examples, known methods, structures, and technologies are not disclosed in detail, so as not to mix up understanding on the specification.

In the claims, any reference signs placed between parentheses shall not be construed as limiting the claims. The term “comprising” does not exclude the presence of elements or steps not listed in the claims. The term “a” or “an” preceding an element does not exclude the presence of a plurality of such elements. This application may be implemented by means of hardware including different elements and an appropriately programmed computer. In the unit claims enumerating several apparatuses, several of these apparatuses may be embodied by a same hardware item. The use of the terms such as first, second, third, and the like does not indicate any order. These terms may be interpreted as names.

Finally, it should be noted that the foregoing embodiments are merely intended for describing technical solutions of this application, but not for limiting this application. Although this application is described in detail with reference to the foregoing embodiments, a person of ordinary skill in the art should understand that modifications may still be made to the technical solutions described in the foregoing embodiments or equivalent replacements may be made to some technical features, and such modifications and replacements do not cause the essence of the corresponding technical solutions to depart from the spirit and scope of technical solutions of embodiments of this application.

What is claimed is:

1. A connector, comprising: an interface and a connecting cable, wherein the interface comprises a housing, a plastic body, and a plurality of metal terminals, wherein
a plurality of first mounting grooves are provided on the plastic body, the metal terminals are in one-to-one correspondence with the first mounting grooves, one of the metal terminals is correspondingly mounted in one of the first mounting grooves, and the housing is sleeved outside the plastic body;
the plurality of metal terminals comprises a power terminal and a ground terminal, the power terminal comprises at least two power pins electrically connected to each other, and the ground terminal comprises at least two ground pins electrically connected to each other; and
the metal terminals are all directly electrically connected to the connecting cable.

2. The connector according to claim 1, wherein the interface further comprises a resistor, and the plurality of metal terminals further comprise a common terminal, wherein
the resistor is electrically connected to the common terminal and the power terminal separately.

3. The connector according to claim 2, wherein a bending platform is disposed on the common terminal, and the resistor is soldered to the bending platform.

4. The connector according to claim 2, wherein the power terminal further comprises a first transverse beam, and the first transverse beam is connected to the at least two power pins respectively, wherein
the resistor is soldered to the first transverse beam.

5. The connector according to claim 1, wherein the at least two power pins are of an integrally formed structure, and the at least two ground pins are of an integrally formed structure.

6. The connector according to claim 1, wherein the power terminal further comprises a first transverse beam and a first terminal solder pin, wherein
the first transverse beam is connected to the at least two power pins respectively;
the first terminal solder pin is connected to the first transverse beam; and
the connecting cable is electrically connected to the first terminal solder pin.

7. The connector according to claim 1, wherein the ground terminal further comprises a second transverse beam and a second terminal solder pin, wherein
the second transverse beam is connected to the at least two ground pins respectively;
the second terminal solder pin is connected to the second transverse beam; and
the connecting cable is electrically connected to the second terminal solder pin.

8. The connector according to claim 7, wherein an elastic sheet toward the housing is disposed on the second transverse beam, and the elastic sheet abuts against the housing, to ground the housing.

9. The connector according to claim 1, wherein the interface further comprises a protection member, and the protection member is connected to a side of the plastic body close to the connecting cable, wherein
the protection member is embedded between the plurality of metal terminals, to support the plurality of metal terminals and implement insulation between the plurality of metal terminals.

10. An electronic device, comprising: a device body and the connector,
wherein the connector comprises an interface and a connecting cable, wherein the interface comprises a housing, a plastic body, and a plurality of metal terminals, wherein
a plurality of first mounting grooves are provided on the plastic body, the metal terminals are in one-to-one correspondence with the first mounting grooves, one of the metal terminals is correspondingly mounted in one of the first mounting grooves, and the housing is sleeved outside the plastic body;
the plurality of metal terminals comprises a power terminal and a ground terminal, the power terminal comprises at least two power pins electrically connected to each other, and the ground terminal comprises at least two ground pins electrically connected to each other;
the metal terminals are all directly electrically connected to the connecting cable; and
the connector is configured to be plugged in the device body.

11. The electronic device according to claim 10, wherein the interface further comprises a resistor, and the plurality of metal terminals further comprise a common terminal, wherein
the resistor is electrically connected to the common terminal and the power terminal separately.

12. The electronic device according to claim 11, wherein a bending platform is disposed on the common terminal, and the resistor is soldered to the bending platform.

13. The electronic device according to claim 11, wherein the power terminal further comprises a first transverse beam, and the first transverse beam is connected to the at least two power pins respectively, wherein
the resistor is soldered to the first transverse beam.

14. The electronic device according to claim 10, wherein the at least two power pins are of an integrally formed structure, and the at least two ground pins are of an integrally formed structure.

15. The electronic device according to claim 10, wherein the power terminal further comprises a first transverse beam and a first terminal solder pin, wherein
the first transverse beam is connected to the at least two power pins respectively;
the first terminal solder pin is connected to the first transverse beam; and
the connecting cable is electrically connected to the first terminal solder pin.

16. The electronic device according to claim 10, wherein the ground terminal further comprises a second transverse beam and a second terminal solder pin, wherein
the second transverse beam is connected to the at least two ground pins respectively;
the second terminal solder pin is connected to the second transverse beam; and
the connecting cable is electrically connected to the second terminal solder pin.

17. The electronic device according to claim 16, wherein an elastic sheet toward the housing is disposed on the second transverse beam, and the elastic sheet abuts against the housing, to ground the housing.

18. The electronic device according to claim 10, wherein the interface further comprises a protection member, and the protection member is connected to a side of the plastic body close to the connecting cable, wherein
the protection member is embedded between the plurality of metal terminals, to support the plurality of metal terminals and implement insulation between the plurality of metal terminals.
